(19) United States
(12) Patent Application Publication
(10) Pub. No.: US 2025/0139941 A1
(43) Pub. Date: May 1, 2025

(54) METHOD AND SYSTEM FOR CLASSIFYING HISTORIC DATA DERIVED FROM NEURAL NETWORKS

(71) Applicant: RAJIV TREHAN, BANGKOK (TH)

(72) Inventor: RAJIV TREHAN, BANGKOK (TH)

(21) Appl. No.: 18/934,527

(22) Filed: Nov. 1, 2024

Related U.S. Application Data
(60) Provisional application No. 63/546,789, filed on Nov. 1, 2023.

(51) Int. Cl. G06V 10/764; G06V 10/82

(52) U.S. Cl. CPC G06V 10/764; G06V 10/82

(57) ABSTRACT

A method for classifying historic data derived from neural networks is disclosed. The method includes creating a vector database based on vector data derived from a first set of layers up to an intermediate layer of a neural network. The vector data corresponds to a plurality of objects and a plurality of attributes processed by the neural network based on a first set of training data used to train the neural network for a first classification objective. The method includes retraining a second set of layers in the neural network excluding the first set of layers and the intermediate layer based on a second classification objective and a second set of training data. The method includes processing the vector database by the retrained second set of layers. The method includes generating at least one of an object classification or an attribute classification based on the processing.

### TECHNICAL FIELD

The present disclosure relates to neural networks, and more particularly to a method and system for classifying historic data derived from neural networks.

### BACKGROUND

A neural network is trained using large representative sets of training data and verification data. The training data, for example, may be a huge repository of images if the neural network is to be trained to identify and/or classify an object from within an image for a specific use case scenario. Training of a neural network also requires back propagation in order to adjust weights at each layer of the neural network in order to improve its identification and/or classification accuracy. For a given classification and/or identification objective, the training data would include data that corresponds to the classification and/or identification objective. By way of an example, if the classification objective is differentiating between cats and dogs, then the training data would include images that include cats and/or dogs which are labelled accordingly.

However, the training data, especially in the form of images, contains high quantum of ancillary data other than the intended object or attribute to be used for training the neural network. In most cases, once the neural network has been trained, a specific training data set is not stored and may get discarded, especially if it has been a while since the neural network was trained using that specific training data set. As a result, all the ancillary data in that specific training data set may get lost. Conventional systems and methods do not have any mechanism of extracting information based on such ancillary data which has now been lost. Such data may have been lost or deleted because of privacy laws, computational constraints, or any act of God (for example, fire, earthquake, floods, or the like).

### SUMMARY

In an embodiment, a method for classifying historic data derived from neural networks is disclosed. The method includes creating a vector database based on vector data derived from a first set of layers up to an intermediate layer of a neural network. The vector data corresponds to a plurality of objects and a plurality of attributes processed by the neural network based on a first set of training data used to train the neural network for a first classification objective. The method further includes retraining each of a second set of layers in the pre-trained neural network excluding the first set of layers and the intermediate layer based on a second classification objective and a second set of training data. The method includes processing the vector database by the second set of layers retrained based on the second classification objective. The method further includes generating at least one of an object classification or an attribute classification based on the processing.

In another embodiment, a system for classifying historic data derived from neural networks is disclosed. The system includes a processor, and a memory communicatively coupled to the processor. The memory includes processor-executable instructions, which when executed by the processor causes the processor to create a vector database based on vector data derived from a first set of layers up to an intermediate layer of a neural network. The vector data corresponds to a plurality of objects and a plurality of attributes processed by the neural network based on a first set of training data used to train the neural network for a first classification objective. The processor-executable instructions, on execution, further cause the processor to retrain each of a second set of layers in the neural network excluding the first set of layers and the intermediate layer based on a second classification objective and a second set of training data. The processor-executable instructions, on execution, further cause the processor to process the vector database by the second set of layers retrained based on the second classification objective. The processor-executable instructions, on execution, further cause the processor to generate at least one of an object classification or an attribute classification based on the processing.

In an embodiment, a method for selectively extracting historical data is disclosed. The method includes receiving a second classification objective as a user input from a user. The method further includes identifying a second set of retrained layers from a plurality of second sets of retrained layers based on the second classification objective. Each of the plurality of second sets of retrained layers is mapped to a corresponding second classification objective. The method further includes processing a vector database by the second set of retrained layers. The vector database is created based on vector data derived from a first set of layers up to an intermediate layer of a neural network. The vector data corresponds to a plurality of objects and a plurality of attributes processed by the neural network based on a first set of training data used to train the neural network for a first classification objective. The method further includes generating at least one of an object classification or an attribute classification based on the processing.

In another embodiment, a system for selectively extracting historical data is disclosed. The system includes a processor, and a memory communicatively coupled to the processor. The memory includes processor-executable instructions, which when executed by the processor causes the processor to receive a second classification objective as a user input from a user. The processor-executable instructions, on execution, further cause the processor to identify a second set of retrained layers from a plurality of second sets of retrained layers based on the second classification objective. Each of the plurality of second sets of retrained layers is mapped to a corresponding second classification objective. The processor-executable instructions, on execution, further cause the processor to process a vector database by the second set of retrained layers. The vector database is created based on vector data derived from a first set of layers up to an intermediate layer of a neural network. The vector data corresponds to a plurality of objects and a plurality of attributes processed by the neural network based on a first set of training data used to train the neural network for a first classification objective. The processor-executable instructions, on execution, further cause the processor to generate at least one of an object classification or an attribute classification based on the processing.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a system configured to classify historic data derived from a neural network, in accordance with some embodiments of the present disclosure.

FIG. 2 illustrates a flowchart of a method for classifying historic data derived from a neural network, in accordance with some embodiments of the present disclosure.

FIG. 3 illustrates a flowchart of a method for processing a vector database by a second set of layers retrained based on a second classification objective, in accordance with some embodiments of the present disclosure.

FIG. 4 illustrates a flowchart of a method for retraining a second set of layers based on a second classification objective, in accordance with some embodiments of the present disclosure.

FIG. 5 illustrates a flowchart of a method for selectively extracting insights from historical data derived from neutral networks, in accordance with some embodiments of the present disclosure.

FIG. 6 illustrates a pictorial representation of training a neural network, in accordance with some embodiments of the present disclosure.

FIG. 7 illustrates a pictorial representation of classification of an input through a neural network, in accordance with some embodiments of the present disclosure.

FIG. 8 illustrates a pictorial representation of retraining a second set of layers of a neural network for a new classification objective, in accordance with some embodiments of the present disclosure.

FIG. 9 illustrates a pictorial representation of classifying historic data stored in vector database by multiple retrained layers, in accordance with some embodiments of the present disclosure.

FIG. 10 illustrates a Graphical User Interface (GUI) for selectively extracting historical data from a vector database, in accordance with some embodiments of the present disclosure.

FIG. 11 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The following description is presented to enable a person of ordinary skill in the art to make and use the invention and is provided in the context of applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the encryption of the invention with unnecessary detail. Thus, the invention is not intended to be limited to the embodiments shown but is to be accorded the widest scope consistent with the principles and features disclosed herein.

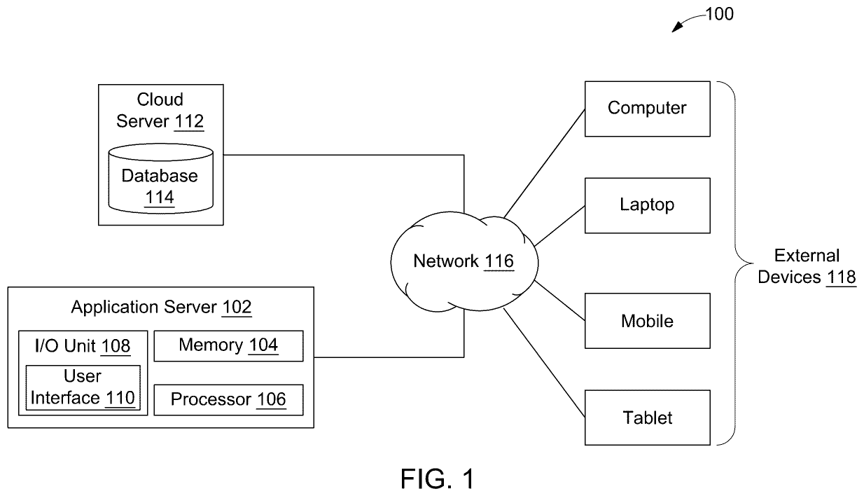

Referring now to FIG. 1, a block diagram of a system configured to classify historic data derived from neural networks is illustrated, in accordance with some embodiments of the present disclosure. In order to classify historic data, the system 100 may include an application server 102. The application server 102 may include a neural network that may reside within a memory 104 of the application server 102. Examples of the neural network may include, but are not limited to Convolution Neural Network (CNN), Recurrent Neural Network (RNN), Long Short-Term Memory (LSTM), stacked autoencoders, and the like.

Initially, the neural network may be trained based on a first set of training data and a first classification objective. The first set of training data may correspond to an initial training dataset used for training the neural network. It should be noted that the neural network may never have been previously trained. The first set of training data that may be used for training the neural network may include, for example, images of cats and dogs. The first classification objective used for training the neural network may include classification of cats and dogs from images provided as input.

Once the neural network is trained based on an initial training dataset, the neural network may be repurposed or retrained for a second (different) classification objective. For this each of a plurality of layers of the neural network may be divided into a first set of layers, an intermediate layer, and a second set of layers. The neural network that is trained based on the first set of training data for the first classification objective may be hosted on the application server 102.

In order to classify historic data derived from the neural network, initially the application server 102 may be configured to create a vector database. The vector database may be created based on vector data derived from the first set of layers up to the intermediate layer of the neural network. The vector data corresponds to a plurality of objects and a plurality of attributes that are processed by the neural network based on the first set of training data used to train the neural network for the first classification objective. Examples of the plurality of objects may include, but are not limited to people, vehicles, roadside stalls/shops, trees, traffic lights, buildings, hoardings, and the like. Further, examples of the plurality of attributes may include, but are not limited to age, gender, color, size, shape, make, and the like associated with an object. The vector data may also include metadata associated with at least one of the plurality of objects and at least one of the plurality of attributes. Examples of the metadata may include, but are not limited to Global Positioning System (GPS) coordinates, camera Identifier (ID), views area, resolution, air-quality, humidity level, precipitation, pollution levels, time and day an image was taken, and weather at the time the image was clicked, or the like.

In an embodiment, each vector (object vector or an attribute vector) would have metadata associated with it. In most of these cases, original reference images based on which vector data has been created may have been lost or deleted. However, if the original reference images may still be available, these original reference images may also be linked via the metadata. The metadata may then be used to enable search index of such available reference images. This search mechanism may be applied to further refine or filter the vector data available in the vector database.

Once the vector database is created, the application server 102 may be configured to retrain each of the second set of layers in the neural network based on a second classification objective and a second set of training data. By way of an example, the second classification objective may be to identify a certain species of trees and thus the second set of training data may include images of varied species of trees. It should be noted that the second set of layers may be retrained by training the entire neural network using the second classification objective and the second set of training data.

It may further be noted that while retraining the neural network, weight allocation of nodes in the neural network and the overall topology may be changed and updated only for the second set of layers. However, the weight allocation of nodes and overall topology for the first set of layers and the intermediate layer may remain the same. In other words, the topology and weight allocations for the first set of layers and the intermediate layer cannot be changed, while one or more of the topology and weight allocation for the second set of layers is modified post retraining. This modification in topology and/or weights is a result of retraining the second set of layers for the second classification objective.

After retraining the second set of layers, the second set of layers may be configured to process the vector database based on the second classification objective. Further, based on the processing, the second set of layers may be configured to generate one of an object classification and an attribute classification for each of the second set of training data based on the second classification objective. In continuation of the above example where the second set of training data includes images of varied species of trees, the second classification objective may be identification of maple trees (object) that are at least 40 meters tall (attribute). The second set of layers may then process the vector database based on the classification objective of identifying maple trees that are 40 meters or taller. Based on the processing, the second set of layers may identify maple trees that are at least 40 meters tall. A total count of such trees may be later determined. Since each object vector and attribute vector have associated metadata, the classification can be further refined using GPS coordinates associated with the vectors to identify only those 40 meter or taller maple trees that are located within a specific geographical area. The classification can further be refined using dates and GPS coordinates associated with vectors to identify overall increase in 40 meter or taller maple trees located within a specific geographical area over a given number of years.

The application server 102 may further include the memory 104, a processor 106, and an Input/Output (I/O) unit 108. The I/O unit 108 may further include a user interface 110. A user may interact with the computing device 102 and vice versa through the I/O unit 108. The I/O unit 108 may be used to display results (i.e., the object classification, the attribute classification, or) based on actions performed by the application server 102, to the user. The user interface 110 may be used by the user to provide inputs to the application server 102. Thus, for example, in some embodiment, the user may ingest an input that includes the second set of training data and the second classification objective.

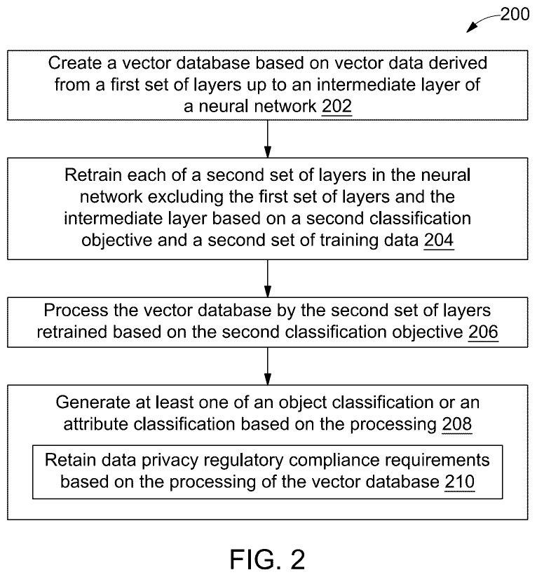

Further, the memory 104 may store instructions that, when executed by the processor 106, may cause the processor 106 to classify historic data from the neural network. As will be described in greater detail in conjunction with FIG. 2 to FIG. 10, in order to classify historic data, the processor 106 in conjunction with the memory 104 may perform various functions including creating the vector database based on vector data derived from the first set of layers up to the intermediate layer of the neural network, retraining each of a second set of layers in the neural network, processing the vector database by the second set of layers retrained based on the second classification objective, and generating at least one of an object classification or an attribute classification based on the processing.

The memory 104 may also store various data (for example, the vector data) that may be captured, processed, and/or required by the system 100. The memory 104 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

Further, the application server 102 may interact with a cloud server 112 or external devices 118 over a network 116 for sending and receiving various data. The network 116, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

In an embodiment, the application server 102 may download a model file that corresponds to the neural network from the cloud server 112. The cloud server 112 may include a database 114. By way of an example, the database 114 may store different classification objectives and a corresponding second set of layers. The database 114 may be periodically updated with a new classification objectives along with a corresponding second set of layers. Alternatively, the application server 102 may receive input from the user from one of the external devices 118. This complete process executed by the system 100 is further explained in detail in conjunction with FIG. 2 to FIG. 10.

Referring now to FIG. 2, a flowchart of a method 200 for classifying historic data derived from a neural network is illustrated, in accordance with some embodiments of the present disclosure. FIG. 2 is explained in conjunction with FIG. 1.

In order to classify historic data, initially at step 202, a vector database may be created based on vector data derived from a first set of layers up to an intermediate layer of the neural network. In an embodiment, the vector data may correspond to a plurality of objects and a plurality of attributes processed by the neural network based on a first set of training data used to train the neural network for a first classification objective. By way of an example, the vector database may include vector attributes and object attributes that correspond to road images captured in the city of Singapore during the period 2000 to 2004. The images may also include photos of different people (objects) and details with regards to what they are wearing and how they look (attributes). Further, at step 204, each of a second set of layers in the neural network may be retrained based on a second classification objective and a second set of training data. The second classification objective may be determining male to female ratio using public transport in the city of Singapore for a given year. It may be noted that while retraining the neural network, weight allocation of nodes and the overall topology may be changed and updated only for the second set of layers. However, the weight allocation of nodes and overall topology for the first set of layers and the intermediate layer may remain the same. In other words, the topology and weight allocations for the first set of layers and the intermediate layer cannot be changed, while one or more of the topology and weight allocation for the second set of layers is modified post retraining. This modification in topology and/or weights is a result of retraining the second set of layers for the second classification objective.

Once the second set of layers is retrained, at step 206, the vector database may be processed by the second set of layers retrained based on the second classification objective. Further, at step 208, at least one of an object classification or an attribute classification may be generated based on the processing. In continuation of the example given above, people (object) using public transport (object) and their respective genders (attributes) may be identified. The total number of such people in the year 2000 may be later derived based on this classification and the associated metadata.

In an embodiment, one of the object classification or the attribute classification may be generated, while retaining data privacy regulatory compliance requirements based on the processing of the vector database, as mentioned via step 210. Since the details associated with people in the extracted vector data is not human-readable nor retrievable, the use of such data may comply with data privacy regulations. Thus, information of interest or special insights may be derived from this historic data, without being in contravention to any data privacy regulations.

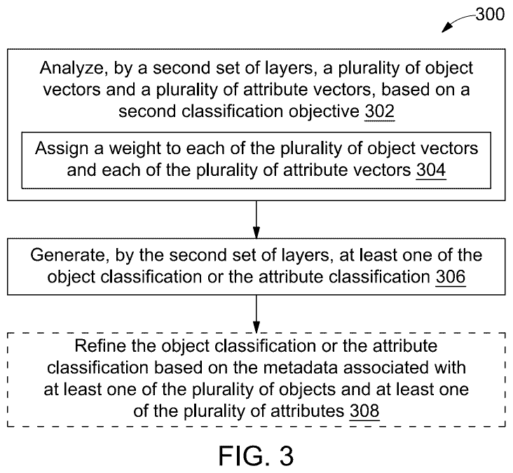

Referring now to FIG. 3, a flowchart of a method 300 for processing a vector database by a second set of layers retrained based on a second classification objective is illustrated, in accordance with some embodiments of the present disclosure. FIG. 3 is explained in conjunction with FIG. 1 and FIG. 2.

With reference to FIG. 2, in order to process the vector database by the second set of layers retrained based on the second classification objective as mentioned via step 206, at step 302, the second set of layers may analyze the plurality of object vectors and the plurality of attribute vectors, based on the second classification objective. In an embodiment, analyzing may include assigning, at step 304, a weight to each of the plurality of object vectors and each of the plurality of attribute vectors. The weights may be assigned in conformance with the second classification objective. By way of an example, the second classification objective may be to identify people (object) who used to wear red colored (attribute) spectacles (object) in a given year in a certain city. In this case, the second set of layers are now targeted to classify the vectors that correspond to red colored spectacles.

Thereafter, based on the weight assigned to each of the plurality of object vectors and each of the plurality of attribute vectors, the second set of layers may generate at least one of the object classification or the attribute classification at step 306. In continuation of the example given above, the second set of layers may identify people wearing red colored spectacles. These classifications may later be counted to determine the total number of people wearing red colored spectacles.

At step 308, the object classification or the attribute classification may further be refined based on the metadata associated with at least one of the plurality of objects and at least one of the plurality of attributes. In continuation of the example given above, the classification may be further refined using metadata that may include GPS coordinates and date and time details to identify people who are wearing red colored spectacles in a given geographical area during a predefined time period.

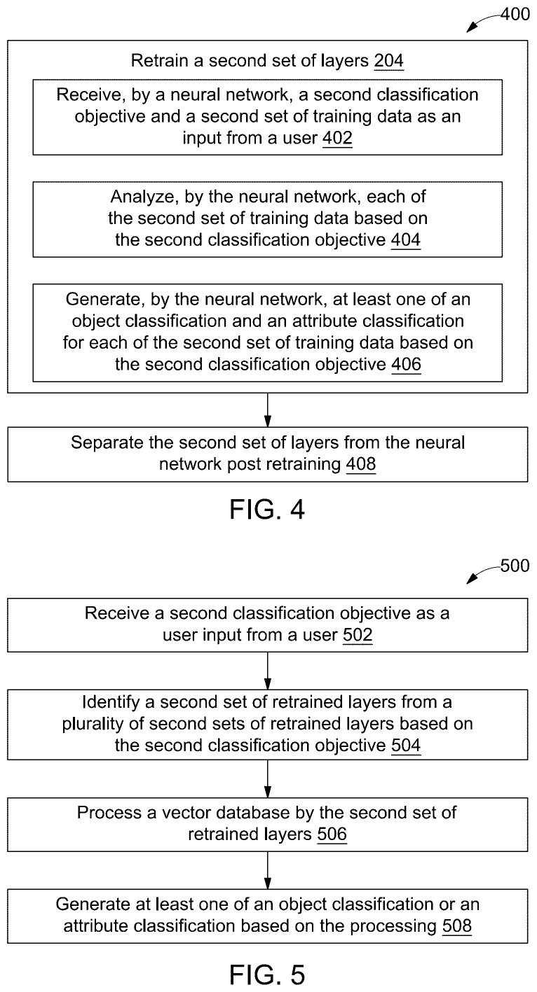

Referring now to FIG. 4, a flowchart of a method 400 for retraining a second set of layers based on a second classification objective is illustrated, in accordance with some embodiments of the present disclosure. FIG. 4 is explained in conjunction with FIG. 1-FIG. 3.

With reference to FIG. 2, in order to retrain the second set of layers as mentioned via step 204, initially at step 402, the neural network may receive the second classification objective and the second set of training data as an input from a user. Upon receiving the second classification objective and the second set of training data, at step 404, the neural network may be retrained to analyze each of the second set of training data based on the second classification objective. Further, based on the analysis of the second set of training data, at step 406, the neural network may generate at least one of an object classification and an attribute classification for each of the second set of training data based on the classification objective.

It may be noted that while retraining the neural network, weight allocation of nodes and the overall topology may be changed and updated only for the second set of layers. However, the weight allocation of nodes and overall topology for the first set of layers and the intermediate layer may remain the same. In other words, the topology and weight allocations for the first set of layers and the intermediate layer cannot be changed, while one or more of the topology and weight allocation for the second set of layers is modified post retraining. This modification in topology and/or weights is a result of retraining the second set of layers for the second classification objective.

Once the neural network has been retrained for the second classification objective, at step 408, the second set of layers may be separated from the neural network. These separated second set of layers may then process the vector database derived from the neural network trained for the first classification objective.

Referring now to FIG. 5, a flowchart of a method 500 for selectively extracting insights from historical data derived from neural networks is illustrated, in accordance with some embodiments of the present disclosure. FIG. 5 is explained in conjunction with FIG. 1-FIG. 4.

In order to selectively extract historical data, at step 502, a second classification objective may be received as a user input from a user. Upon receiving the classification objective, at step 504, a second set of retrained layers may be identified from a plurality of second sets of retrained layers. The second set of layers may be identified based on the classification objective. In an embodiment, each of the plurality of second sets of retrained layers may be mapped to a corresponding classification objective. In other words, each of the plurality of second sets of retrained layers may have been retrained for a different classification objective. As a result, there may be a near exhaustive collection of second set of retrained layers, such that, each second set of retrained layers is designated for a given classification objective.

Once the second set of retrained layers for the second classification objective is identified, the second set of retrained layers may then process a vector database derived from the first set of layers up to the intermediate layer of the neural network at step 506. In an embodiment, the vector database may be created based on vector data derived from a first set of layers up to an intermediate layer of the neural network trained for a first (different) classification objective. The vector data may correspond to a plurality of objects and a plurality of attributes processed by the neural network based on a first set of training data used to train the neural network for the first classification objective. Further, at step 508, the second set of retrained layers may generate at least one of an object classification or an attribute classification based on the processing.

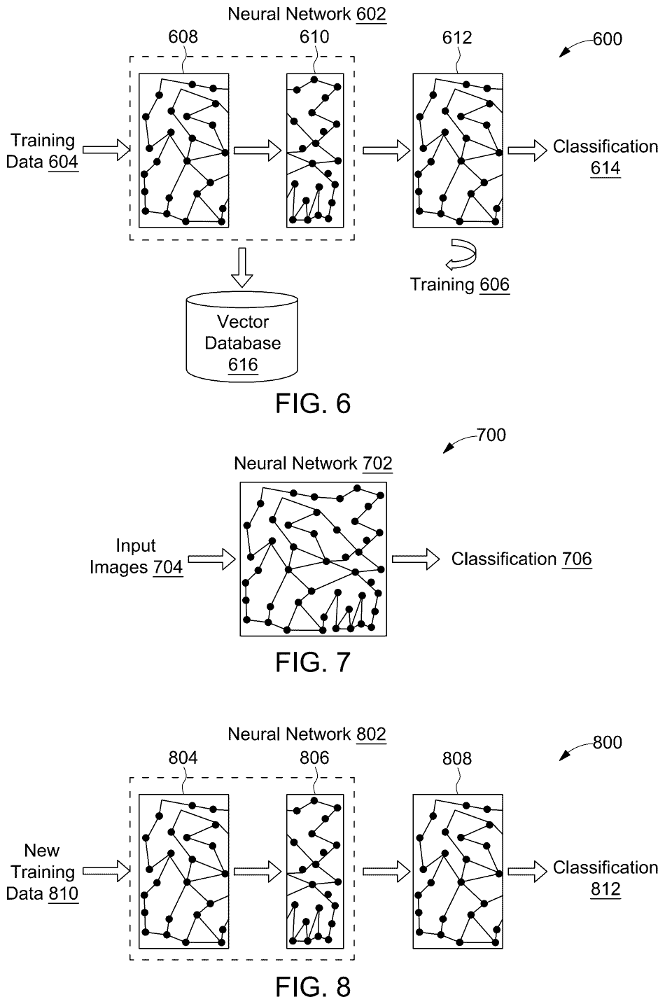

Referring now to FIG. 6, a pictorial representation 600 of training a neural network 602 is illustrated, in accordance with some embodiments of the present disclosure. FIG. 6 is explained in conjunction with FIG. 1-FIG. 5.

The neural network 602 may correspond to a neural network that has never been trained. Examples of the neural network may include, but are not limited to, a Convolution Neural Network (CNN), a Recurrent Neural Network (RNN), a Long Short-Term Memory (LSTM), stacked autoencoders, or the like. In an embodiment, the neural network 602 may include a plurality of layers. The plurality of layers may include a first set of layers 608, an intermediate layer 610, and a second set of layers 612. As depicted, the first set of layers 608 precede the intermediate layer 610, and the second set of layers 612 succeeds the intermediate layer.

As depicted in FIG. 6, the neural network 602 may be trained using a training data 604. The training data 604 may correspond to the first set of training data. In addition to the training data 604, a classification objective may also be provided as the input to the neural network 602. In an embodiment, the training data 604 may include various images. It will be apparent to a person skilled in the art that images are discussed in this and subsequent figures for ease of depiction and understanding. However, the invention is not limited to the training data 604 being images and may include any other form of data.

The training data 604, for example, may include multiple images that include cars. The classification objective may be identification of cars from the training data 604. As will be appreciated, the training data 604 may include various angles, lighting conditions, backgrounds, and types of vehicles (including cars) that are labelled. The training data 604 may be provided as an input to the neural network 602 in order to train the neural network 602 as mentioned via training mechanism 606 (that may include back propagation and human in the loop).

Once trained, the neural network 602 may be configured to generate one of an object classification and an attribute classification depicted as classification 614 for input images. In continuation of the example given above, the neural network 602 may be able to identify which input images include cars (or even a specific car model).

After the training, the first set of layers 608 up to the intermediate layer 610 of the neural network 602 may include vector data that may correspond to a plurality of objects and a plurality of attributes processed by the neural network 602 from the training data 604. This vector data may be derived from the first set of layers 608 up to the intermediate layer 610 to create a vector database 616. The vector database 616 may be a goldmine of historical data captured from various old images. Numerous special insights and information can be derived by processing this vector database 616 via the neural network 602 retrained for a different purpose or classification objective.

Referring now to FIG. 7, a pictorial representation 700 of classification of an input through a neural network 702 is illustrated in accordance with some embodiments of the present disclosure. FIG. 7 is explained in conjunction with FIG. 1-FIG. 6. The neural network 702 may be analogous to the neural network 602.

Once the neural network 702 is trained for classifying each image based on a given classification objective (for example, the classification objective of identifying cars), the neural network 702 may be able to identify and classify cars from the input images provided to the neural network 702. Input images 704 may be provided as an input to the neural network 704 to generate a classification 706. By way of an example, the input images 704 may include images of vehicles and some of these vehicles may be cars. Upon receiving the input images 704, the neural network 702 may generate the classification 806. The classification objective, for example, may be identification of all yellow-colored cars from the input images 704. In this case, the classification 706 may be cars (i.e., the object) that are colored yellow (i.e., the attribute).

Referring now to FIG. 8, a pictorial representation 800 of retraining a second set of layers of a neural network 802 for a new classification objective is illustrated, in accordance with some embodiments of the present disclosure. FIG. 8 is explained in conjunction with FIG. 1-FIG. 7.

With reference to FIG. 7, the neural network 802 may be analogous to the neural network 602. The neural network 802 may include a first set of layers 804, an intermediate layer 806, and a second set of layers 808. In order to retrain the second set of layers 808 for the new classification objective, the neural network 802 needs to be retrained entirely. For example, the new classification objective may be different from the initial classification objective of identifying yellow-colored cars from input images. The new classification objective, for example, may be identifying pillion riders on two wheelers who are not wearing helmets.

To this end, a new training data 810 may be fed into the neural network 802 along with the new classification objective. In an embodiment, the new training data 810 may correspond to the second set of training data. The second set of training data may include various images that include bikes with and without pillion riders who may or may not be wearing helmets. Once retrained based on the new classification objective, the neural network 802 may be configured to generate a classification 812, i.e., one of the object classification or the attribute classification for each image in the new training data 810. It may be noted that while retraining the neural network 802, weight allocation of nodes and the overall topology may be changed and updated only for the second set of layers 808. However, the weight allocation of nodes and overall topology for the first set of layers 804 and the intermediate layer 806 may remain the same. In other words, the topology and weight allocations for the first set of layers 804 and the intermediate layer 806 cannot be changed, while one or more of the topology and weight allocation for the second set of layers 808 is modified post retraining. This modification in topology and/or weights is a result of retraining the second set of layers 808 for the second classification objective.

After the neural network 802 has been retrained for the new classification objective, the second set of layers 808 may be separated out from the neural network 802. The second set of layers 808 that have been separated out may be referred to as retrained layers in the subsequent description.

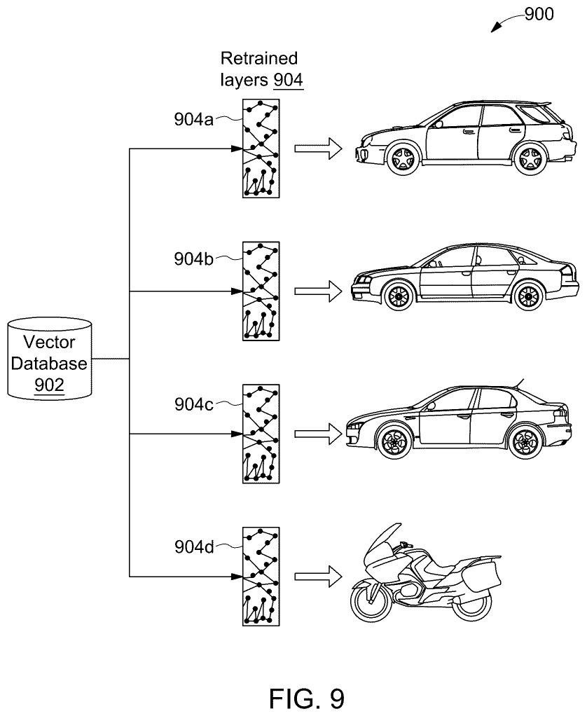

Referring now to FIG. 9, a pictorial representation 900 of classifying historic data stored in a vector database 902 by multiple retrained layers 904 is illustrated, in accordance with some embodiments of the present disclosure. FIG. 9 is explained in conjunction with FIG. 1-FIG. 8. The vector database 902 is same as the vector database 616 derived from the first set of layers 608 up to the intermediate layer 610 of the neural network 602. It may be noted that each of the retrained layers 904 are second set of layers that have been retrained for a specific classification objective. It may be further noted vector data in the vector database 616 may correspond to images captured in the year 2000. In other words, the vector data may correspond to historic or old data.

The retrained layers 904 may be configured to process the vector database 902 to generate one of an object classification or an attribute classification based on the classification objective for which each of the retrained layers 904 have been respectively retrained. The retrained layers 904 may include retrained layers 904a, retrained layers 904b, retrained layers 904c, and retrained layers 904d. The retrained layers 904a may have been retrained with the classification objective of identifying red colored (attribute) AUDI® cars (object), the retrained layers 904b may have been retrained with the classification objective of identifying black colored (attribute) BMW® cars (object), the retrained layers 904c may have been retrained with the classification objective of identifying green colored (attribute) SUZUKI® cars (object), and the retrained layers 904d may have been retrained with the classification objective of identifying blue colored (attribute) YAMAHA® bikes (object).

Thus, the same vector database 902 when processed by the retrained layers 904a may identifying red colored AUDI® cars in the year 2000. While the same vector database 902 may identify black colored BMW® cars in the year 200, the retrained layers 904c may identify green colored SUZUKI® cars, and the retrained layers 904d may identify blue colored YAMAHA® bikes. In other words, the same vector database 902 can be fed as an information goldmine to different sets of retrained layers configured or repurposed for a different and new objective to extract extremely specific insights and useful information from the historic data. Thus, irrespective of historical images not being currently available or accessible for regulatory or other reasons, this very insightful hidden data (in the form of vector data) can be analyzed by way of this invention to extract deep and special insights. These deep insights, for example, may be the rate of deforestation or afforestation within a city over a period of time. By way of another example, these deep insights may be the rate of increase in pollution within a city over a period of time.

Additionally, using just the retrained layers (i.e., the second set of layers, excluding the first set of layers and the intermediate layers) to process the vector database 902, contribute to reducing overall size of the neural network. As a result, computational requirement to extract insights and information from the vector database 902 may also be reduced.

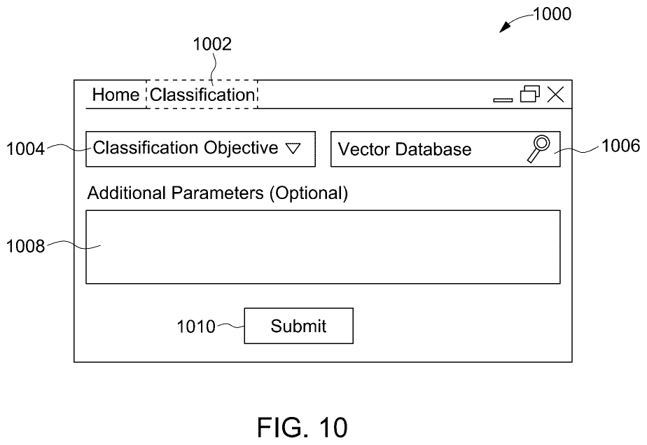

It may be noted that the insight extraction from the vector database 902 can be focused based on precise requirements. This is enabled by using the metadata that is associated with the vector data in the vector database 902. In some embodiments, a Graphical User Interface (GUI) may be provided where a user may be able to specify a classification objective (for example, rate of deforestation) along with inputs with regards to a date range and a location. Based on these inputs, a specific classifier (retrained layers) trained for the given classification objective may be selected and the vector data in the vector database 902 may be provided as input to the specific classifier to generate and provide the required insights to the user via the GUI. This is further explained in conjunction with FIG. 10.

Referring now to FIG. 10, a GUI 1000 for selectively extracting historical data from the vector database 902 is illustrated in accordance with some embodiments of the present disclosure. FIG. 10 is explained in conjunction with FIG. 1-FIG. 9.

In order to selectively extract historical data, the user may provide the classification objective as the user input via the GUI 1000. To this end, the user may click on a classification button 1002. Upon clicking the classification button 1002, the user may select a classification objective from a drop-down menu via a classification objective field 1004. The user may further be required to select a specific vector database from a data field 1006, based on the type and range of historical data that is required to be processed for extraction of special insights. The user may also be able to provide additional parameters via an additional parameters field (optional) 1008 corresponding to the classification objective. These additional parameters may correspond to the metadata that is associated with vector data in the vector database selected by the user. For example, when the classification objective includes classification of people wearing blue colored clothes, then the additional parameters may include limitations with respect to geographical region, year, and/or time of the year. It should be noted that the additional parameters are optional, and the user may or may not provide the additional parameters as the user input.

Additionally, once classification has been done based on a selected classification objective, the outcome of the classification may further be used as additional metadata that may be augmented with vectors in the vector database 902. This additional metadata may then be presented as addition parameters via the additional parameters field (optional) 1008.

Upon selecting the classification objective, when the user may click on a submit button 1010, a second set of retrained layers may be identified from a plurality of second sets of retrained layers. The second set of retrained layers may have been trained for the classification objective selected by the user. The second set of retrained layers may then process the vector database selected by the user (for example, the vector database 902) to generate classifications based on the classification objective. Numerous examples of such classifications have been provided above for ease of understanding.

As will also be appreciated, the above-described techniques may take the form of computer or controller-implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

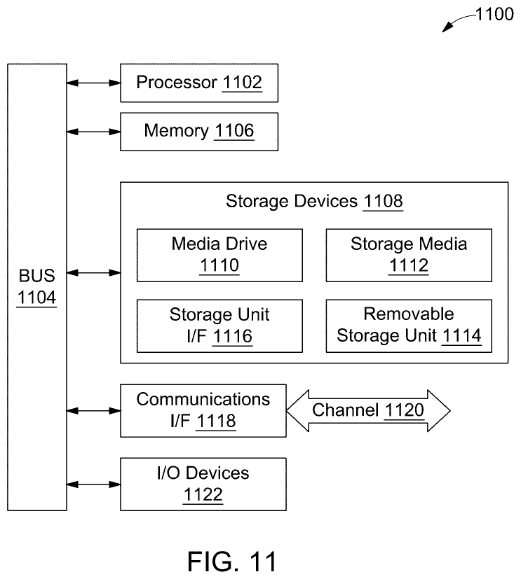

The disclosed methods and systems may be implemented on a conventional or a general-purpose computer system, such as a personal computer (PC) or server computer. Referring now to FIG. 11, an exemplary computing system 1100 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1100 may represent, for example, a user device such as a desktop, a laptop, a mobile phone, personal entertainment device, DVR, and so on, or any other type of special or general-purpose computing device as may be desirable or appropriate for a given application or environment. The computing system 1100 may include one or more processors, such as a processor 1102 that may be implemented using a general or special purpose processing engine such as, for example, a microprocessor, microcontroller, or other control logic. In this example, the processor 1102 is connected to a bus 1104 or other communication medium. In some embodiments, the processor 1102 may be an Artificial Intelligence (AI) processor, which may be implemented as a Tensor Processing Unit (TPU), or a graphical processor unit, or a custom programmable solution Field-Programmable Gate Array (FPGA).

The computing system 1100 may also include a memory 1106 (main memory), for example, Random Access Memory (RAM) or other dynamic memory, for storing information and instructions to be executed by the processor 1102. The memory 1106 also may be used for storing temporary variables or other intermediate information during execution of instructions to be executed by the processor 1102. The computing system 1100 may likewise include a read only memory (“ROM”) or other static storage device coupled to bus 1104 for storing static information and instructions for the processor 1102.

The computing system 1100 may also include storage devices 1108, which may include, for example, a media drive 1110 and a removable storage interface. The media drive 1110 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1112 may include, for example, a hard disk, magnetic tape, flash drive, or other fixed or removable medium that is read by and written to by the media drive 1110. As these examples illustrate, the storage media 1112 may include a computer-readable storage medium having stored therein particular computer software or data.

In alternative embodiments, the storage devices 1108 may include other similar instrumentalities for allowing computer programs or other instructions or data to be loaded into the computing system 1100. Such instrumentalities may include, for example, a removable storage unit 1114 and a storage unit interface 1116, such as a program cartridge and cartridge interface, a removable memory (for example, a flash memory or other removable memory module) and memory slot, and other removable storage units and interfaces that allow software and data to be transferred from the removable storage unit 1114 to the computing system 1100.

The computing system 1100 may also include a communications interface 1118. The communications interface 1118 may be used to allow software and data to be transferred between the computing system 1100 and external devices. Examples of the communications interface 1118 may include a network interface (such as an Ethernet or other NIC card), a communications port (such as for example, a USB port, a micro-USB port), Near field Communication (NFC), etc. Software and data transferred via the communications interface 1118 are in the form of signals which may be electronic, electromagnetic, optical, or other signals capable of being received by the communications interface 1118. These signals are provided to the communications interface 1118 via a channel 1120. The channel 1120 may carry signals and may be implemented using a wireless medium, wire or cable, fiber optics, or other communications medium. Some examples of the channel 1120 may include a phone line, a cellular phone link, an RF link, a Bluetooth link, a network interface, a local or wide area network, and other communications channels.

The computing system 1100 may further include Input/Output (I/O) devices 1122. Examples may include, but are not limited to a display, keypad, microphone, audio speakers, vibrating motor, LED lights, or the like. The I/O devices 1122 may receive input from a user and also display an output of the computation performed by the processor 1102. In this document, the terms “computer program product” and “computer-readable medium” may be used generally to refer to media such as, for example, the memory 1106, the storage devices 1108, the removable storage unit 1114, or signal(s) on the channel 1120. These and other forms of computer-readable media may be involved in providing one or more sequences of one or more instructions to the processor 1102 for execution. Such instructions, generally referred to as “computer program code” (which may be grouped in the form of computer programs or other groupings), when executed, enable the computing system 1100 to perform features or functions of embodiments of the present invention.

In an embodiment where the elements are implemented using software, the software may be stored in a computer-readable medium and loaded into the computing system 1100 using, for example, the removable storage unit 1114, the media drive 1110 or the communications interface 1118. The control logic (in this example, software instructions or computer program code), when executed by the processor 1102, causes the processor 1102 to perform the functions of the invention as described herein.

As will be appreciated by those skilled in the art, the techniques described in the various embodiments discussed above are not routine, or conventional, or well understood in the art. The techniques discussed above provided for classifying historic data derived from neural networks. The techniques may first create a vector database based on vector data derived from a first set of layers up to an intermediate layer of a neural network. The vector data may correspond to a plurality of objects and a plurality of attributes processed by the neural network based on a first set of training data used to train the neural network for a first classification objective. The techniques may then retrain each of a second set of layers in the neural network excluding the first set of layers and the intermediate layer based on a second classification objective and a second set of training data. The techniques may then process the vector database by the second set of layers retrained based on the second classification objective. The techniques may then generate at least one of an object classification or an attribute classification based on the processing.

Thus, the disclosed method and system try to overcome the technical problem of classifying historic data derived from neural networks. The disclosed method and system may use vector data derived from a neural network for a different identification and/or classification objective. The vector data derived from a first set of layers up to the intermediate layer is used to create a vector database, which is a data goldmine. Once the vector database has been created, it may be provided as an input to a second set of layers (excluding the first set of layers and the intermediate layer) that have been retrained or repurposed for a completely different objective. Once the second set of layers have been retrained, these may process the vector database and generate classifications based on the new classification objective. Thus, the same vector database that corresponds to old or historic information (which may no longer be available in its original form) may be processed by different such retrained layers to extract specific and special insights. Additionally, use of the vector data stored in the vector database and providing it as input to multiple retrained layers based on end classification objective, may meet the data privacy regulatory compliance requirements in various countries. This may help avoid any data breaches or leakages that may occur because of humans in the loop. Also, use of just the retrained layers from the neural network may contribute in reducing the computational requirement for storing and executing the neural network.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a method and system for classifying historic data derived from neural networks. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, or the like, of those described herein) will be apparent to a person skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for classifying historic data derived from neural networks, the method comprising:
creating a vector database based on vector data derived from a first set of layers up to an intermediate layer of a neural network, wherein the vector data corresponds to a plurality of objects and a plurality of attributes processed by the neural network based on a first set of training data used to train the neural network for a first classification objective;
retraining each of a second set of layers in the neural network excluding the first set of layers and the intermediate layer based on a second classification objective and a second set of training data;
processing the vector database by the second set of layers retrained based on the second classification objective; and
generating at least one of an object classification or an attribute classification based on the processing.

2. The method of claim 1, wherein the neural network comprises the first set of layers, the intermediate layer, and the second set of layers, and wherein the first set of layers precedes the intermediate layer, and the second set of layers succeeds the intermediate layer.

3. The method of claim 1, wherein the vector data comprises:
a plurality of object vectors;
a plurality of attribute vectors; and
metadata associated with at least one of the plurality of objects and at least one of the plurality of attributes.

4. The method of claim 3, wherein processing the vector database by the second set of layers retrained based on the second classification objective comprises:
analyzing, by the second set of layers, the plurality of object vectors and the plurality of attribute vectors, based on the second classification objective, wherein analyzing comprises:
assigning a weight to each of the plurality of object vectors and each of the plurality of attribute vectors; and
generating, by the second set of layers, at least one of the object classification or the attribute classification based on the weight assigned to each of the plurality of object vectors and each of the plurality of attribute vectors.

5. The method of claim 4, further comprising refining the object classification or the attribute classification based on the metadata associated with at least one of the plurality of objects and at least one of the plurality of attributes.

6. The method of claim 1, wherein retraining the second set of layers comprises:
receiving, by the neural network, the second classification objective and the second set of training data as an input from a user;
analyzing, by the neural network, each of the second set of training data based on the second classification objective; and
generating, by the neural network, at least one of an object classification and an attribute classification for each of the second set of training data based on the second classification objective to retrain the neural network.

7. The method of claim 6, further comprising separating the second set of layers from the neural network post retraining of the neural network, wherein the vector database is processed by the second set of layers after separating from the neural network.

8. The method of claim 1, wherein generating the at least one of the object classification or the attribute classification comprises retaining data privacy regulatory compliance requirements based on the processing of the vector database.

9. A method for selectively extracting historical data, the method comprising:
receiving a second classification objective as a user input from a user;
identifying a second set of retrained layers from a plurality of second sets of retrained layers based on the second classification objective, wherein each of the plurality of second sets of retrained layers is mapped to a corresponding second classification objective;
processing a vector database by the second set of retrained layers, wherein the vector database is created based on vector data derived from a first set of layers up to an intermediate layer of a neural network, and wherein the vector data corresponds to a plurality of objects and a plurality of attributes processed by the neural network based on a first set of training data used to train the neural network for a first classification objective; and
generating at least one of an object classification or an attribute classification based on the processing.

10. A system for classifying historic data derived from neural networks, the system comprising:
a processor; and
a memory coupled to the processor, wherein the memory stores processor executable instructions, which, on execution, causes the processor to:
create a vector database based on vector data derived from a first set of layers up to an intermediate layer of a neural network, wherein the vector data corresponds to a plurality of objects and a plurality of attributes processed by the neural network based on a first set of training data used to train the neural network for a first classification objective;
retrain each of a second set of layers in the neural network excluding the first set of layers and the intermediate layer based on a second classification objective and a second set of training data;
process the vector database by the second set of layers retrained based on the second classification objective; and
generate at least one of an object classification or an attribute classification based on the processing.

11. The system of claim 10, wherein the neural network comprises the first set of layers, the intermediate layer, and the second set of layers, and wherein the first set of layers precedes the intermediate layer, and the second set of layers succeeds the intermediate layer.

12. The system of claim 10, wherein the vector data comprises:
a plurality of object vectors;
a plurality of attribute vectors; and
metadata associated with at least one of the plurality of objects and at least one of the plurality of attributes.

13. The system of claim 12, wherein, to process the vector database by the second set of layers retrained based on the second classification objective, the processor-executable instructions, on execution, further cause the processor to:
analyze, by the second set of layers, the plurality of object vectors and the plurality of attribute vectors, based on the second classification objective, wherein analyzing comprises, wherein to analyze, the processor-executable instructions, on execution, further cause the processor to:
assign a weight to each of the plurality of object vectors and each of the plurality of attribute vectors; and
generate, by the second set of layers, at least one of the object classification or the attribute classification based on the weight assigned to each of the plurality of object vectors and each of the plurality of attribute vectors.

14. The system of claim 12, the processor-executable instructions, on execution, further cause the processor to refine the object classification or the attribute classification based on the metadata associated with at least one of the plurality of objects and at least one of the plurality of attributes.

15. The system of claim 10, wherein, to retrain the second set of layers, the processor-executable instructions, on execution, further cause the processor to:
receive, by the neural network, the second classification objective and the second set of training data as an input from a user;
analyze, by the neural network, each of the second set of training data based on the second classification objective; and
generate, by the neural network, at least one of an object classification and an attribute classification for each of the second set of training data based on the second classification objective to retrain the neural network.

16. The system of claim 15, the processor-executable instructions, on execution, further cause the processor to separate the second set of layers from the neural network post retraining of the neural network, wherein the vector database is processed by the second set of layers after separating from the neural network.

17. The system of claim 10, wherein, to generate the at least one of the object classification or the attribute classification, the processor-executable instructions, on execution, further cause the processor to:
retain data privacy regulatory compliance requirements based on the processing of the vector database.

18. A system for selectively extracting historical data, the system comprising:
a processor; and
a memory coupled to the processor, wherein the memory stores processor executable instructions, which, on execution, causes the processor to:
receive a second classification objective as a user input from a user;
identify a second set of retrained layers from a plurality of second sets of retrained layers based on the second classification objective, wherein each of the plurality of second sets of retrained layers is mapped to a corresponding second classification objective;
process a vector database by the second set of retrained layers, wherein the vector database is created based on vector data derived from a first set of layers up to an intermediate layer of a neural network, and wherein the vector data corresponds to a plurality of objects and a plurality of attributes processed by the neural network based on a first set of training data used to train the neural network for a first classification objective; and
generate at least one of an object classification or an attribute classification based on the processing.
